(19) United States
(12) Patent Application Publication
(10) Pub. No.: US 2008/0059726 A1
(43) Pub. Date: Mar. 6, 2008

(54) Dynamic measurement of an operating system in a virtualized system

(76) Inventors: Carlos Rozas, Portland, OR (US); Rolf Neugebauer, Cambridge (GB)

Correspondence Address: SCHUBERT, OSTERRIEDER & NICKELSON, PLLC;c/o Intellevate, P.O. BOX 52050, MINNEAPOLIS, MN, 55402, US

(21) Appl. No.: 11/513,963

(22) Filed: Aug. 31, 2006

(51) Int. Cl. G06F 12/00

(52) U.S. Cl. 711/156

(57) ABSTRACT

Systems, methods, and media for dynamic measurement of operating systems in a virtualized system are disclosed. Some embodiments may include accessing a dirty bitmap associated with an operating system executing in a virtualized system where the dirty bitmap may include an indication of memory locations that have been modified since a previous access. Embodiments may also include analyzing the dirty bitmap to determine one or more memory locations associated with the operating system to measure and measuring the determined memory locations to produce measurements of the memory locations. Embodiments may also include performing an action based on the measurements of the memory locations. Other embodiments are disclosed and claimed.

### BACKGROUND

A conventional virtual machine monitor (VMM) typically runs on a computer and presents to other software the abstraction of one or more virtual machines. Each virtual machine (VM) may function as a self-contained platform running its own ‘guest operating system’ (guest OS). These VMs may contain standard operating systems such as Microsoft Corporation's Microsoft Windows®, Linux, or other operating systems and may each be executing simultaneously. The VMM typically intercepts and arbitrates accesses made by guest operating systems to computer resources so that the guest operating systems believe that they have control over various computer operations and access to the computer's central processing unit (CPU), physical memory and I/O devices during these operations. The VMM may thus allow multiple guest operating systems to share the resources of a physical host platform.

Security remains a complicated and important problem for computer systems as intruders continue to attack systems to cause damage, misappropriate information, or perform other unauthorized tasks. Virtualized systems present particular opportunities and challenges for intrusion detection and protecting systems against attack. Intrusion detection systems for virtualized systems include external and internal runtime integrity monitors and other measurement agents. Current intrusion detection systems typically scan or monitor an operating system for indications that the operating system is no longer operating in a trustworthy manner, which may indicate that a rootkit, virus, or other intruder is present. To accomplish this, many virus scanners and other intrusion detection systems scan for signatures of known malware (e.g., rootkits, viruses, etc.). This solution has a drawback, however, that the intrusion detection system must know the signature of the intruder in order to detect it. To detect unknown intruders, many intrusion detection systems check and measure relevant portions of memory and compare the results against a ‘known good state’ to search for signs of intrusion. Such a process, however, can be resource-intensive as the intrusion detection system must continually check all relevant portions of the memory as the system is unable to determine a priori which pages of the memory have been updated or changed. The resource-intensive nature of these systems often requires temporary suspension of the execution of the VM to measure the entire operating system (and not just the working set), resulting in undesired downtime of the operating system. System designers may also trade-off security for availability and performance by performing their scans incrementally. Furthermore, external intrusion detection systems (those outside the virtualized system) generally cannot provide consistency guarantees about their measurements as updates to physical memory may happen asynchronously with their checks and cannot access processor state information.

### BRIEF DESCRIPTION OF THE DRAWINGS

Embodiments of the invention may be illustrated by way of example, and not by way of limitation, in the following detailed description and in figures of the accompanying drawings in which like references may indicate similar elements:

FIG. 1 depicts a virtual machine environment including a virtual machine monitor, guest operating system, and a,measurement agent according to some embodiments;

FIG. 2 depicts a block diagram of one embodiment of a computer system suitable for executing one or more components of the virtual machine environment;

FIG. 3 depicts a conceptual illustration of software components of a measurement agent according to some embodiments; and

FIG. 4 depicts a flowchart of an embodiment to measure memory locations of a guest OS utilizing a dirty bitmap for the guest OS.

### DETAILED DESCRIPTION OF EMBODIMENTS

The following is a detailed description of example embodiments of the invention depicted in the accompanying drawings. The example embodiments are introduced in such detail as to clearly communicate the invention. However, the embodiments presented herein are merely illustrative, and are not intended to limit the anticipated variations of such embodiments; on the contrary, the intention is to cover all modifications, equivalents, and alternatives falling within the spirit and scope of the appended claims. The detailed descriptions below are designed to make such embodiments obvious to those of ordinary skill in the art.

Generally speaking, systems, methods, and media for dynamic measurement of operating systems in a virtualized system are disclosed. Some embodiments may include accessing a dirty bitmap associated with an operating system executing in a virtualized system where the dirty bitmap may include an indication of memory locations that have been modified since a previous access. Embodiments may also include analyzing the dirty bitmap to determine one or more memory locations associated with the operating system to measure and measuring the determined memory locations to produce measurements of the memory locations. Embodiments may also include performing an action based on the measurements of the memory locations.

Other embodiments comprise an article comprising a machine-readable medium that contains instructions, which when executed by a processing platform, cause said processing platform to perform a series of operations. Embodiments may include a series of operations for accessing a dirty bitmap associated with an operating system executing in a virtualized system. Embodiments may also include a series of operations for analyzing the dirty bitmap to determine one or more memory locations associated with the operating system to measure and measuring the determined memory locations to produce measurements of the memory locations. Embodiments may also include a series of operations for performing an action based on the measurements of the memory locations

Other embodiments may include a virtual machine environment system including a virtual machine monitor and a first virtual machine that includes a guest operating system. Embodiments may also include a measurement agent to iteratively measure memory associated with the guest operating system. The measurement agent may include a dirty bitmap analyzer to access and analyze a dirty bitmap associated with the guest operating system to determine one or more memory locations associated with the operating system that have changed since a previous access. The measurement agent may also include a measurement module to measure the determined memory locations to produce measurements of the memory locations. Further embodiments of the memory agent may also include an operating system integrity module to perform an action based on the measurements of the memory locations.

Other embodiments may include a measurement agent system including a dirty bitmap analyzer, a measurement module, and an operating system integrity module. The dirty bitmap analyzer of some embodiments may access and analyze a dirty bitmap associated with the guest operating system to determine one or more memory locations associated with the operating system that have changed since a previous access. The measurement module of some embodiments may measure the determined memory locations to produce measurements of the memory locations. The operating system integrity module of some embodiments may perform an action based on the measurements of the memory locations.

The disclosed system and methodology may advantageously provide for dynamic measurement of operating systems in a virtualized, system. By iteratively accessing a dirty bitmap for an operating system, the disclosed system may determine which memory pages or other locations have changed since the last time the system accessed and measured the memory. The disclosed system may then measure only the changed pages (and optionally other related pages) without having to continually measure each memory page, providing an efficient and effective methodology of measuring memory associated with an operating system.

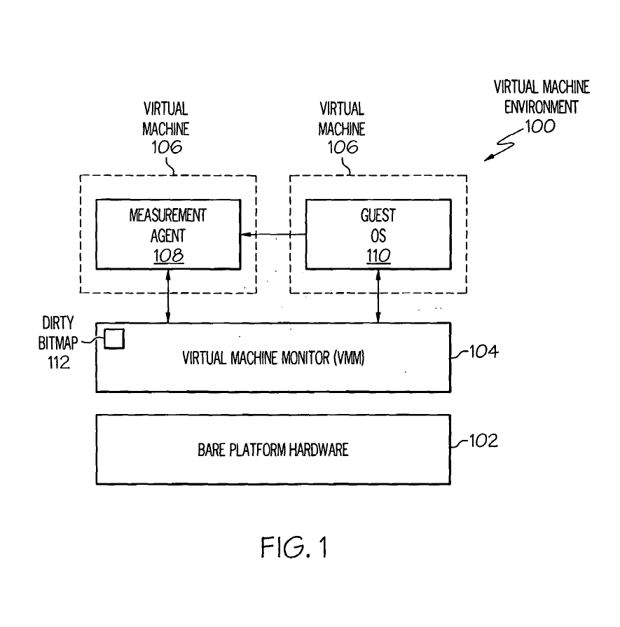

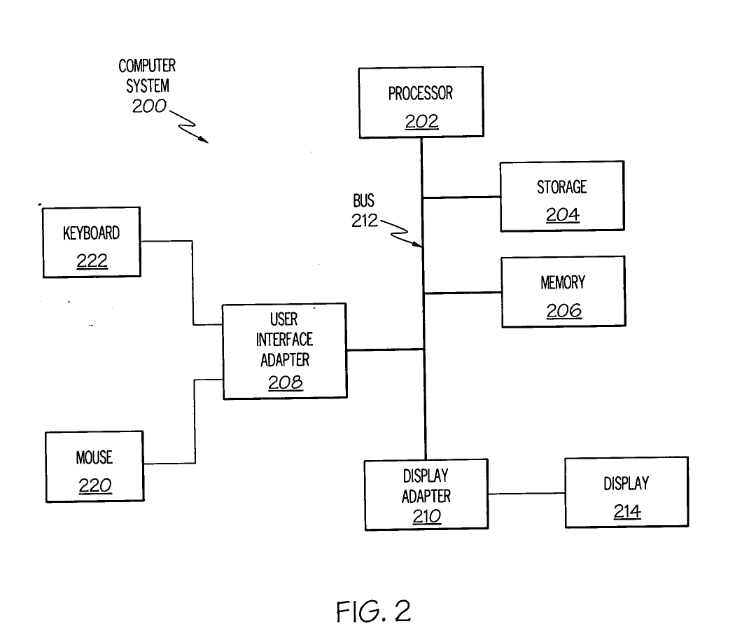

Turning now to the drawings, FIG. 1 depicts a virtual machine environment including a virtual machine monitor, guest operating system, and a measurement agent according to some embodiments. The virtual machine environment 100 may execute on one or more computer systems, such as the computer systems described in relation to FIG. 2. The disclosed virtual machine environment 100 includes bare platform hardware 102 and a virtual machine monitor (VMM) 104. The bare platform hardware 102 may comprise a computing platform which may be capable, for example, of executing a standard operating system (OS) and/or a virtual machine monitor such as VMM 104. Operating systems may include standard operating systems such as, for example, Microsoft Corporation's Microsoft Windows® or Linux operating systems, or may include smaller operating systems. VMM 104 may typically be implemented in software and may export a bare machine interface to system software. In some embodiments, the VMM 104 may export a modified machine interface to system software where the modifications typically simplify the task of virtualization and may improve the performance of the VMM 104. Such system software may include a standard or real-time OS, an additional VM, or other system. Example VMM's 104 include those compatible with Xen (an open-source VMM and released under the terms of the GNU General Public License and that was developed by the University of Cambridge), VMware® (from VMware, Inc., a subsidiary of EMC Corporation), and many others. VMMs and their typical features and functionality are well-known by those skilled in the art and may be implemented, for example, in software, firmware, or by other technologies or combinations of technologies.

VMM 104 may present to other software (i.e., “guest” software) the abstraction of one or more virtual machines (VMs) 106. In the depicted embodiment, the VMM 104 presents two virtual machines 106. One virtual machine 106 includes a guest OS 110 and may also include various guest applications (not shown) executing on the guest OS 110. The second virtual machine 106 includes a measurement agent 108 for measuring memory associated with another operating system, such as the guest OS 110 of a separate virtual machine 106, as will be described in more detail subsequently. The second virtual machine 106 may also include a guest OS 110 as well as other guest applications. Each guest OS 110 may control access to physical resources, such as memory and memory-mapped I/O devices, via the VMM 104. The VMM 104 may typically have ultimate control over the physical resources to provide protection from and between different virtual machines 106, providing an interface between the virtual machines 106 and the bare platform hardware 102 so that multiple virtual machines 106, and thus multiple guest OS's 110, may execute on the same hardware. To accomplish this, the VMM 104 may intercept accesses of the guest OS's 110 to the computer's physical resources by “trapping” attempts to access and controlling the operation initiated by the guest OS 110. The VMM 104 may also use any other technique known in the art to manage VMs 106.

The VMM 104 may include a dirty bitmap 112 associated with a guest OS 110 that is created when a virtual machine 106 hosting the guest OS 110 is in a dirty logging mode (such as implemented by Xen) or other mode or other methodology that creates a bitmap of changed pages or other locations. A dirty bitmap may provide an indication of some or all of the memory locations (such as pages) used by a guest OS 110 as well as an indication of whether the memory locations have changed since a previous access. The dirty bitmap 112 may thus provide a log of which memory locations associated with a guest OS 110 have been “dirtied”, or modified. In one embodiment, a dirty bitmap may have a bit for each memory page of a guest OS 110 where one bit value (e.g., a one) indicates that a change has occurred and the opposite bit value indicates that no change has occurred. As will be described in more detail subsequently, an application accessing the dirty bitmap 112 for a guest OS 110 (such as the measurement agent 108) may reset any bits indicating changed pages to effectively reset, or initialize, the dirty bitmap 112 after the application has completed determining which memory locations have changed since the last access.

A VMM 104 may generate dirty bitmaps 112 for any virtual machines 106 that the VMM 104 is managing. The ability to log memory changes and store an indication of such changes in a dirty bitmap 112 may be part of a standard VMM 104 in some embodiments while in other embodiments, the dirty bitmap 112 generation capability may be added functionality. In some embodiments, activation of dirty logging (i.e., beginning to generate and create a dirty bitmap 112) may be turned on and off for different virtual machines 106.

In some VMM's 104, dirty bitmaps are presently used for the application of live managed migration of an OS from one platform to another over a network. Typically in managed migration, the process of migration is performed by control software daemons running in management virtual machines of both the source and destination hosts. The migration daemons may create a new virtual machine at the destination and coordinate transfer of live system state over a network. When transferring the memory image of the live, and thus still-running, OS, the control software may perform rounds of copying in which it performs a scan of the source VM's memory pages. After a first complete round, the control software only copies pages that were dirtied during the previous round (i.e., since the last round of copying) in an iterative scanning and reading process. To accomplish this, the control software accesses a dirty bitmap that it copies from the VMM of the source platform. In one example, the control software may copy the dirty bitmap from a Xen VMM at the start of each round. In this example, to log pages that are dirtied Xen inserts shadow page tables underneath the running guest OS. The shadow tables are populated on demand by translating sections of the guest page tables. Xen may then trap changes to the pages and set the appropriate bit in the dirty bitmap when changes are made to the pages. The methodology used in live managed migration to create a dirty bitmap may also be used by the measurement agent 108, as will be described in more detail subsequently. One skilled in the art will recognize, however, the dirty logging methodology used by Xen is only one example and that other types of methodologies to create a dirty bitmap, or its equivalent, may also be utilized.

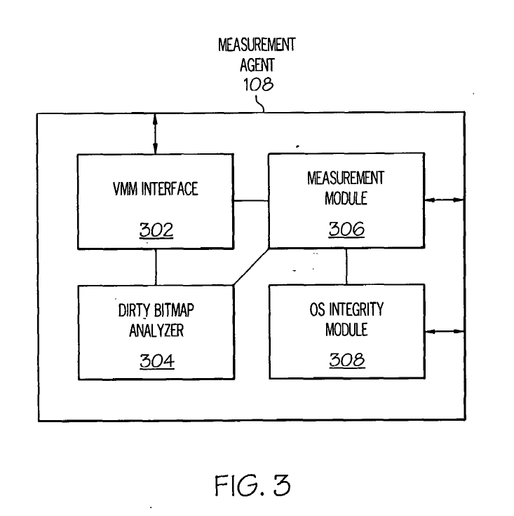

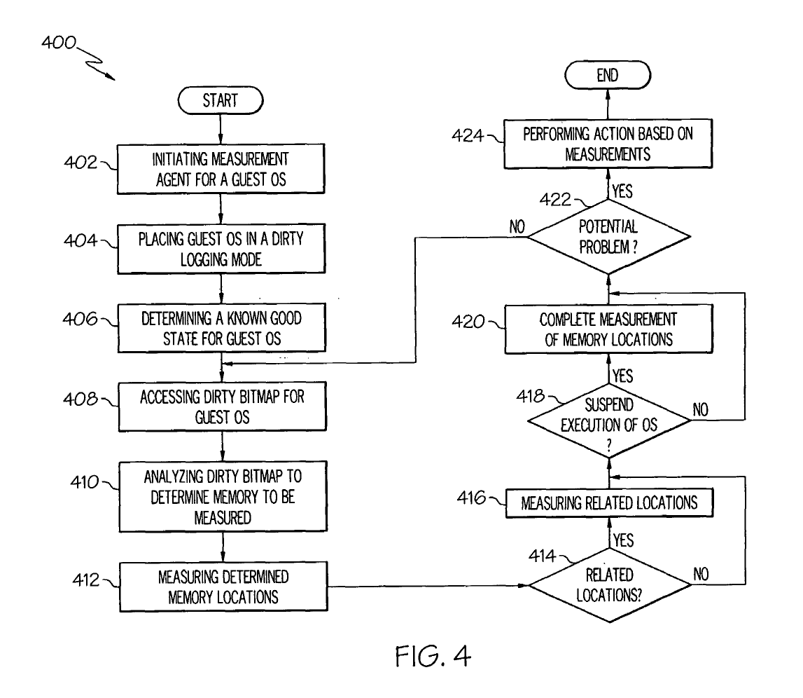

The measurement agent 108, as will be described in more detail in relation to FIGS. 3 and 4, may measure an operating system such as a guest OS 110 to help determine the integrity of the operating system. The measurement agent 108 may measure a guest OS 110 and may utilize the dirty bitmap 112 associated with the guest OS 110 to reduce the processing requirements and time required to perform the measurements. The measurement agent 108 may iteratively scan and read the dirty map 112 and, instead of transferring memory pages as in a live management migration system, may perform measurements on the changed memory pages or other locations. On each successive round, the measurement agent 108 may check to see if a previously measured memory page has been changed and, if so, will then perform measurement actions on that page. Measurement actions may include re-measuring the memory page as well as measuring other related memory pages and optionally adding those related pages to a list for future measurement. In some embodiments, the measurement agent 108 may need to suspend the execution of the guest OS 110 in order to complete its measurement operations due to changes related to the working set of the operating system. The iterative nature of the measurement agent's 108 actions, however, eliminates the need to suspend operation of the guest OS 110 in most cases. In the relatively rare case when the measurement agent 108 must suspend guest OS 110 operation to complete its measurements, such suspension may be of a relatively short length as only a subset of total memory pages need be measured.

By measuring portions of memory that have changed, the measurement agent 108 may assist in determining whether a guest OS 110 is compromised, such as by intruders to the guest OS 110. The measurement agent 108 accordingly may provide an effective and efficient solution to measuring operating systems in a virtualized system. By using iterative access of a dirty bitmap 112, the measurement agent 108 may utilize the information contained within the dirty bitmap 112 to measure only memory locations that have changed since the last measurement, potentially eliminating needless processing of memory locations that have not changed as well as greatly reducing the need to suspect execution of the guest OS 110 being measured.

FIG. 2 depicts a block diagram of one embodiment of a computer system 200 is suitable for executing one or more components of the virtual machine environment 100. Other possibilities for the computer system 200 are possible, including a computer having capabilities other than those ascribed herein and possibly beyond those capabilities, and they may, in other embodiments, be any combination of processing devices such as workstations, servers, mainframe computers, notebook or laptop computers, desktop computers, personal digital assistants (PDAs), mobile phones, wireless devices,; set-top boxes, or the like. At least certain of the components of computer system 200 may be mounted on a multi-layer planar or motherboard (which may itself be mounted on the chassis) to provide a means for electrically interconnecting the components of the computer system 200.

In the depicted embodiment, the computer system 200 includes a processor 202, storage 204, memory 206, a user interface adapter 208, and a display adapter 210 connected to a bus 212. The bus 212 facilitates communication between the processor 202 and other components of the computer system 200, as well as communication between components. Processor 202 may include one or more system central processing units (CPUs), processors, and/or cores to execute instructions, including processors from Intel Corporation such as an Intel® Pentium® processor, an Intel® Itanium® 2 processor, an Intel® Xeon® processor, or any other suitable processor. The processor 202 may utilize storage 204, which may be non-volatile storage such as one or more hard drives, tape drives, diskette drives, CD-ROM drive, DVD-ROM drive, or the like. The processor 202 may also be connected to memory 206 via bus 212 (or other interconnect), such as via a memory controller hub (MCH). System memory 206 may include volatile memory such as random access, memory (RAM) or double data rate (DDR) synchronous dynamic random access memory (SDRAM). The processor 202, system memory 206, and other components of the computer system 200 may be part of the bare platform hardware 102 of FIG. 1 to which the VMM 104 manages access.

The user interface adapter 208 may connect the processor 202 with user interface devices such as a mouse 220 or keyboard 222. The user interface adapter 208 may also connect with other types of user input devices, such as touch pads, touch sensitive screens, electronic pens, microphones, etc. The bus 212 may also connect the processor 202 to a display, such as an LCD display or CRT monitor, via the display adapter 210.

FIG. 3 depicts a conceptual illustration of software components of a measurement agent 108 according to some embodiments. As described previously (and in more detail in relation to FIG. 4), the measurement agent 108 may measure a guest OS 110 running on a virtual machine 106 in a virtual machine environment 100 and may utilize a dirty bitmap 112 associated with the guest OS 110 to facilitate the measurements. The measurement agent 108 may execute on, for example, the same virtual machine 106 as a guest OS 110, on a second virtual machine 106, within the VMM 104, or anywhere within the virtual machine environment 100. The measurement agent 108 may include a VMM interface 302, a dirty bitmap analyzer 304, a measurement module 306, and an OS integrity module 308 in some embodiments. The measurement agent 108 may be decomposed, as well, and components of the measurement agent 108 may execute in different locations. For example, the OS integrity module 308 may reside in a separate VM 106 from other components of the measurement agent 108.

The VMM interface 302 may provide for communication between components of the measurement agent 108 and the VMM 104. In some embodiments, the VMM interface 302 may facilitate access of a dirty bitmap 112 for a particular guest OS 110, such as by transmitting a request for such access to the VMM 104 or by accessing the stored dirty bitmap 112 in the VMM 104 or other storage location. The VMM interface 302 may also, in some embodiments, receive a dirty bitmap 112 or information from a dirty bitmap 112 from the VMM 104 or other component. In alternative embodiments, the VMM interface 302 may also transmit a request to the VMM 104 to begin dirty logging of a particular guest OS 110.

The dirty bitmap analyzer 304 may access and analyze a dirty bitmap 112 associated with a particular guest OS 110 in order to determine one or more memory locations (such as memory pages) associated with the guest OS 110. In some embodiments, the dirty bitmap analyzer 112 may scan and read the dirty bitmap 112 to see if a previously measured memory location has been changed and, if so, may notify the measurement module 306 that the memory location has changed since the last measurement. Once the dirty bitmap analyzer 304 has determined the memory locations that have changed, the dirty bitmap analyzer 304 of some embodiments may change the value of those locations in the dirty bitmap 112 to “initialize” the dirty bitmap 112 for subsequent operations. In this fashion, the dirty bitmap analyzer 304 may facilitate reuse of the dirty bitmap 112 in successive iterations to detect subsequent memory changes. As an example, if the dirty bitmap 112 includes a bit for each memory page associated with a guest OS 110, the dirty bitmap analyzer 304 may analyze each bit and determine if the value of the bit (e.g., a ‘1’ indicates a change) indicates that the memory page has changed. In the example described above, the VMM 104 may reset the bits of the dirty bitmap 112 (e.g., changing the ‘1’ values to ‘0’ values) upon request by the dirty bitmap analyzer 304 so that the dirty bitmap 112 is prepared to record subsequent changes. In this fashion, the dirty bitmap 112 may get reset automatically when it is read by the dirty bitmap analyzer 304. Alternatively, the dirty bitmap analyzer 304 may then reset those bit values so that the dirty bitmap 112 is prepared to record changes subsequent to the current measurement cycle.

In some embodiments, the dirty bitmap analyzer 304 may only analyze a subset of the total memory locations associated with a guest OS 110. This may occur, for example, if the dirty bitmap analyzer 304 focuses on memory locations that are typically more susceptible to attack or damage, such as indirection tables or pages of function pointers. By limiting the scope of the dirty bitmap analyzer's 304 analysis (and thus the measurement module's 306 processing), the measurement agent 108 may focus its efforts on higher priority memory locations and save processing time and other resources.

The measurement module 306 may measure the changed memory locations determined by the dirty bitmap analyzer 304 to produce measurements of the memory locations. The measurement module 306 may receive an indication of which memory locations have changed since the last measurement from the dirty bitmap analyzer 304. The measurement module 306 may thus restrict its measurements to memory locations that have changed since the last measurement cycle (along with any determined related pages). Measurement techniques may include hashing or any other type of measurement methodology. Another example measurement technique is to verify that the data structures contained within the page meet certain constraints, such as verifying that function pointers within the data structures only point to legitimate entry-points within the operating system. The measurement module 306 may, in some embodiments, measure the determined memory locations by comparing the current measurements of the memory locations to a known good state. For example, the measurement module 306 may compare the hash of the current contents of a memory location with a previously measured hash of the memory location when the guest OS 110 was in a known good state. As described previously, the measurement module 306 may suspend execution of the operating system to complete its measurement of the memory locations in some alternative embodiments. In other alternative embodiments, the measurement module 304 may also determine related memory locations and measure those memory locations in addition to the determined memory locations, as will be described in more detail in relation to FIG. 4.

The OS integrity module 308 may perform an action based on the measurements generated by the measurement module 306. The action performed by the OS integrity module 308 may include halting execution of the operating system, generating a notification associated with the measurements, and/or logging an indication of the measurements in a log file. As one example, the OS integrity module 308 may analyze measurements to determine if any provide an indication of an integrity problem and record any such determines in a log or, for more severe threats, may suspend execution of the guest OS 110 that is potentially a threat. One skilled in the art will recognize that the OS integrity module 308 may perform any action with the measurement results, including notifying other components or individuals in the event of a problem.

FIG. 4 depicts a flowchart of an embodiment to measure memory locations of a guest OS 110 utilizing a dirty bitmap for the guest OS 110. In one embodiment, one or more components of the VMM 104 and/or the measurement agent 108 may perform the elements of flowchart 400. In the depicted embodiment, flowchart 400 begins with initializing the measurement agent 108 for a particular guest OS 110 at optional element 402. In some embodiments, a VMM 104 or other component of the virtual machine environment 100 may initiate the measurement agent 108, while in other embodiments the measurement agent 108 may begin flowchart 400 already in operation or may initiate itself (such as in response to a user request). At optional element 404, the VMM 104 may place the guest OS 110 into a dirty logging mode (assuming such a mode is not the default). In some embodiments, the VMM 104 may initiate the dirty logging mode at the request of the measurement agent 108.

The measurement agent 108 may determine a known good state for the guest OS 110 at element 406. In some embodiments, the measurement agent 108 may determine measurements for the guest OS 110 at the beginning of its monitoring process and use that state as a known good state, making the assumption that the guest OS 110 is not compromised at the beginning of the monitoring. In other embodiments, the measurement agent 108 may use a stored measurement state or other methodology to determine a known good state.

Beginning at element 408, the measurement agent 108 and its components may use iterative cycles to measure changed memory locations during operation of the guest OS 110. At element 408, the dirty bitmap analyzer 304 may access the dirty bitmap 112 associated with the particular guest OS 110 to be measured and, at element 410, the dirty bitmap analyzer 304 may analyze the dirty bitmap 112 to determine one or more memory locations that have changed since the last cycle and thus should be measured. In some embodiments, the dirty bitmap analyzer 304 may perform elements 410 and 412 by reading and scanning the dirty bitmap 112 stored at the VMM 104. In one example, the dirty bitmap analyzer 304 may analyze each bit of a dirty bitmap 112 and determine if the value of the bit (e.g., a ‘1’ indicates a change) indicates that the associated memory page has changed. In some embodiments, the dirty bitmap 112 may automatically be reset by the VMM 104 after access. The dirty bitmap analyzer 304 may also, in other embodiments, modify the dirty bitmap 112 to reset or initialize the dirty bitmap 112 for subsequent cycles. In this example, the dirty bitmap analyzer 304 may reset any bit values indicating a change to an unchanged state to configure the dirty bitmap 112 for the next measurement cycle.

The dirty bitmap analyzer 304 may also determine at element 410 if there are any related memory locations to any that have changed that should also be measured. The dirty bitmap analyzer 304 may use any methodology to determine if there any related memory locations, such as by determining related locations when a virtual file system or dynamic data structures exist. In one example, if a changed memory location is a particular memory page that now points to other memory page as part of a dynamic data structure, the dirty bitmap analyzer 304 may follow the pointer to the new memory page and determine that the new page should also be measured. The new pages may thus be included in a list of memory pages to “watch” by iterative measurements.

The measurement module 306 may, at element 412, measure the memory locations determined at element 410. As described previously, the measurement module 306 may utilize any measurement methodology, such as comparing a hashed value of the current memory location with a hashed value from a known good state. If the measurement module 306 determines at decision block 414 that related pages were determined by the dirty bitmap analyzer 304, the method of flow chart 400 may continue to element 416, where the measurement module 306 may measure the related memory locations as well.

At decision block 418, the measurement module 306 may determine if it needs to suspend execution of the guest OS 110 in order to complete its measurements. If the measurement module 306 determines to suspend execution of the guest OS 110, it may do so (or request the VM 104 that the suspension occur) and then, at element 420, may complete measurement of the remaining memory locations to be measured. The measurement module 306 may determine to suspend execution if it cannot complete its measurement operations due to changes related to the working set of the guest OS 110. In most cases, however, suspension need not occur as the iterative nature of the measurement cycles allows the measurement agent 108 and its components to make its measurement in a timely fashion. In the relatively rare case when the measurement module 306 determines that it must suspend guest OS 110 operation, such suspension may be of a relatively short length as only a subset of total memory pages need be measured.

The OS integrity module 308 may determine at decision block 422 whether the measurements of the measurement module 306 indicate a problem or necessitate any action. If no action is required and no problem exists, the method of flow chart 400 may return to element 408 for continued execution and beginning the next iterative measurement cycle. Similarly, the method of flow chart 400 may return to element 408 for the next cycle if the OS integrity module 308 determines that action is required but does suspension or termination of the guest OS 110 is not required and execution will continue (and, thus, measurement of the guest OS 110 should continue). If a potential problem does exist, the OS integrity module 308 may at element 414 perform an action based on the measurements, after which the method terminates. As described previously, the action performed by the OS integrity module 308 may include actions such as halting execution of the operating system, generating a notification associated with the measurements, or logging an indication of the measurements in a log file.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

It will be apparent to those skilled in the art having the benefit of this disclosure that the present invention contemplates systems, methods, and media for dynamic measurement of operating systems in a virtualized system. It is understood that the form of the invention shown and described in the detailed description and the drawings are to be taken merely as examples. It is intended that the following claims be interpreted broadly to embrace all the variations of the example embodiments disclosed. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
accessing a dirty bitmap associated with an operating system execution, the dirty bitmap comprising an indication of memory locations that have been modified since a previous access;
analyzing the dirty bitmap to determine one or more memory locations associated with the operating system to measure; and
measuring the determined memory locations to produce measurements of the memory locations.

2. The method of claim 1, further comprising initializing a measurement agent for the operating system.

3. The method of claim 1, further comprising placing the operating system in a dirty logging mode.

4. The method of claim 1, further comprising determining a known good state for the operating system.

5. The method of claim 1, further comprising performing an action based on the measurements of the memory locations.

6. The method of claim 4, wherein measuring the determined memory locations to produce measurements of the memory location comprises comparing the memory locations to the determined known good state.

7. The method of claim 1, wherein the one or more memory locations comprise one or more memory pages.

8. The method of claim 1, wherein measuring the determined memory locations to produce measurements of the memory location comprises measuring memory locations related to the determined memory locations in addition to the determined memory locations.

9. The method of claim 1, wherein measuring the determined memory locations to produce measurements of the memory location comprises suspending execution of the operating system to complete measurement of the memory locations.

10. The method of claim 1, wherein performing an action based on the measurements of the memory locations comprises one or more of halting execution of the operating system, generating a notification associated with the measurements, and logging an indication of the measurements.

11. An article comprising a machine-readable medium that contains instructions, which when executed by a processing platform, cause said processing platform to perform operations comprising:
accessing a dirty bitmap associated with an operating system executing in a virtualized system, the dirty bitmap comprising an indication of memory locations that have been modified since a previous access;
analyzing the dirty bitmap to determine one or more memory locations associated with the operating system to measure; and
measuring the determined memory locations to produce measurements of the memory locations.

12. The machine-accessible medium of claim 11, further comprising initializing a measurement agent for the operating system.

13. The machine-accessible medium of claim 11, further comprising determining a known good state for the operating system.

14. The machine-accessible medium of claim 13, wherein measuring the determined memory locations to produce measurements of the memory location comprises comparing the memory locations to the determined known good state.

15. The machine-accessible medium of claim 11, wherein the one or more memory locations comprise one or more memory pages.

16. The machine-accessible medium of claim 11, wherein measuring the determined memory locations to produce measurements of the memory location comprises measuring memory locations related to the determined memory locations in addition to the determined memory locations.

17. The machine-accessible medium of claim 11, wherein measuring the determined memory locations to produce measurements of the memory location comprises suspending execution of the operating system to complete measurement of the memory locations.

18. The machine-accessible medium of claim 11, wherein performing an action based on the measurements of the memory locations comprises one or more of halting execution of the operating system, generating a notification associated with the measurements, and logging an indication of the measurements.

19. A virtual machine environment system, comprising:
a virtual machine monitor (VMM);
a first virtual machine, the first virtual machine comprising a guest operating system; and
a measurement agent to iteratively measure memory associated with the guest operating system, the measurement agent comprising:
a dirty bitmap analyzer to access and analyze a dirty bitmap associated with the guest operating system to determine one or more memory locations associated with the operating system that have changed since a previous access; and
a measurement module to measure the determined memory locations to produce measurements of the memory locations.

20. The system of claim 19, further comprising a second virtual machine, and wherein the measurement agent executes on the second virtual machine.

21. The system of claim 19, wherein the measurement agent further comprises an operating system integrity module to perform an action based on the measurements of the memory locations.

22. The system of claim 19, wherein the measurement agent further comprises an VMM interface to facilitate communication between the measurement agent and the virtual machine monitor.

23. The system of claim 19, wherein the measurement module measures the determined memory locations by comparing the memory locations to a known good state.

24. The system of claim 19, wherein the one or more memory locations comprise one or more memory pages.

25. A measurement agent system, comprising:
a dirty bitmap analyzer to access and analyze a dirty bitmap associated with a guest operating system to determine one or more memory locations associated with the operating system that have changed since a previous access;
a measurement module to measure the determined memory locations to produce measurements of the memory locations; and
an operating system integrity module to perform an action based on the measurements of the memory locations.

26. The system of claim 25, further comprising a virtual machine monitor (VMM) interface to facilitate communication with a virtual machine monitor.

27. The system of claim 25, wherein the measurement agent system executes on a virtual machine (VM).

28. The system of claim 25, wherein the measurement module measures the determined memory locations by comparing the memory locations to a known good state.

29. The system of claim 25, wherein the one or more memory locations comprise one or more memory pages.
